(19) United States
(12) Patent Application Publication
(10) Pub. No.: US 2017/0005890 A1
(43) Pub. Date: Jan. 5, 2017

(54) SYSTEM AND METHOD FOR AUTOMATIC DATA COLLECTION

(71) Applicant: Mohammed Zulfiquar, Birmingham (GB)

(72) Inventor: Mohammed Zulfiquar, Birmingham (GB)

(21) Appl. No.: 15/193,278

(22) Filed: Jun. 27, 2016

Related U.S. Application Data
(60) Provisional application No. 62/188,632, filed on Jul. 4, 2015.

(51) Int. Cl. H04L 12/26; G06N 3/08; H04L 29/08

(52) U.S. Cl. CPC H04L 43/08; H04L 67/12; G06N 3/08

(57) ABSTRACT

A system for automatic data collection where the system comprises of a plurality of modules for data collection, a local control unit and a remote server. The modules are dispersed along the length of the pipeline to generate a plurality of real time data and the local control unit collects and collates the data collected by the modules and organizes the generated data into meaningful information which is then sent to the remote server. The modules further comprises of at least one flexible composite layer, at least one layer of electronic circuitry embedded on the flexible composite layer, and a plurality of nanosensors embedded on the flexible composite layer (FIG. 2B). The method for automatic data collection where the steps of the method are collecting the real time data from the local modules, transferring the data from the local modules to the local control unit and the data is stored as information at the local control unit. The sorting of the information is based on a plurality of parameters, followed by transferring the sorted information to the remote server, where the remote server receives, stores and processes the received signal, and generates an instruction data which is sent as an output signal to the local control unit. The local control unit receives the output signals, stores and processes the output signal, and generates a respective signal for the local modules and transmitting the respective signals to the local modules for the final action (FIG. 1).

### CROSS-REFERENCE TO RELATED APPLICATIONS

The present application is related to and claims priority from prior provisional application No. 62/188632, filed Jul. 4, 2015.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### TECHNICAL FIELD

Embodiments described herein relate to the field of data collection and more particularly to the field of collecting of data captured by a plurality of modules. More particularly, embodiments described herein relate to the data collection and management so that data can be transferred efficiently to a remote server from the modules and vice versa using a local control unit.

### BACKGROUND

The developing national economy is leading to the rational use of the underground space especially in urban regions. Hence underground pipelines are important in cities and towns to potentially use the underground space. The underground pipelines are the most convenient mode of transportation of fluids across the globe. At the same time maintenance of these pipelines are crucial from leakage and theft. These issues can affect the output of the oil and gas communities from all over the world. In Nigeria alone, for instance, oil pipeline theft reduces output by approximately 15% per annum representing a loss of more than $7 billion. Due to the sensitivity of these thefts, the true figure may be even greater than the considerable 16,083 recorded pipeline breaks in the last decade. Similarly, leakage in the pipelines is great threat to environment, which badly affects surroundings and living beings around the leakage area.

Furthermore, the pipelines at times carry flammable or explosive material such as oil and natural gas which makes it further necessary to stop the leakage to avoid any major incidents or accidents. Such pipelines can be easy targets for vandalism, sabotage, or terrorist or even military attacks during wars.

Various efforts have been done in past to overcome above mentioned issues using various methods or tools which include conducting statistical analysis, performing airborne reconnaissance, regular monitoring of pressure in the pipelines, using Computational Pipeline Monitoring (CPM) software, etc. However these methods and tools are limiting in respect of the factors required to be monitored in a particular region of the pipeline for which an exhaustive separate analysis is made on the pipes before its installation.

Furthermore, wherever such methods or tools are installed along the pipelines, they are generally utilized as data collection tools or method which sends all the collected data to a specific data center for processing, which increases the load on the data center and delays the information relevant to the pipeline.

In regard to the problem mentioned above, very few innovations have taken place that is to collate and sort the generated data and pass only the crucial data to the central server. This is largely due to the fact that the pipelines were new and risks were determined to be low. In addition, the value of oil or gas was relatively low, at around $10 per barrel, which made pipeline theft virtually non-existent. The world today now has a far different landscape as the price of oil and gas per barrel hovers around $100. Because of the changes, the oil and gas industry is desperate to address the massive financial losses and environmental degradation that are associated with both pipeline theft and leakage. In addition, the pipeline industry is grappling with mounting regulatory pressures.

Unfortunately, the lack of innovation and effective investment in research and development to address these issues has meant that the solutions 20 years ago are no different to the ones offered today by servicing companies. Accordingly, there exists a need for innovation in relation to the pipeline integrity, where the entire pipeline is prevented or monitored on a regular basis and that also reduces such delays in generating data and reducing load on the central servers.

### SUMMARY

The present invention aims to provide a method and a system to collect and collate the data. More particularly, the system should be able to collect the data from the plurality of modules which are communicably configured on a pipeline system. These modules are used to monitor any changes that a pipeline system may undergo due to change in surrounding conditions and generate real time data relating to the pipeline, where the data relates to pipeline leakage, prediction of stress and strain, fatigue measurement, corrosion and erosion, future leakage or failure, and detection of any attempt to theft or tempering in the pipeline. The data generated by modules shall be transferred efficiently to a remote server via a local control unit. More particularly, embodiments described herein relate to the method and the system of automatic data collection.

However, this summary is not an extensive overview of the disclosure. It is intended to neither identify key or critical elements of the disclosure, nor to delineate the scope of the present disclosure. Rather, the sole purpose of this summary is to present some concepts of the disclosure, its objects, and advantages in a simplified form as a prelude to the more detailed description that is presented hereinafter.

The present object of the invention is to develop the system and method which is required for the collection of a large amount of data from the modules, collating the data in a systematic manner so as to draw meaningful information.

A further object of the invention is that the system should be able to collect the real time data from the modules to protect the pipeline system from leakage, theft and to access the future leakage so that protective measures can be taken on time.

A further object of the invention is that the real time data should cover all the parameters of the pipeline system in a cost effective manner.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 illustrates block diagram of a pipeline protection system, in accordance with an exemplary embodiment of the present disclosure;

FIG. 2A illustrates assembled view of a module that is configurable on pipelines, in accordance with an exemplary embodiment of the present disclosure;

FIG. 2B illustrates exploded view of a module that is configurable on pipelines, in accordance with an exemplary embodiment of the present disclosure;

FIG. 3 illustrates a block diagram depicting the connection of the major components of the integrated pipeline protection system; and

FIG. 4 illustrates the functional flowchart.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

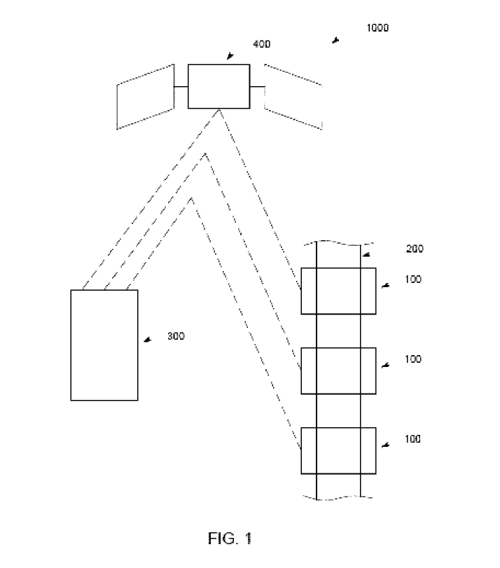

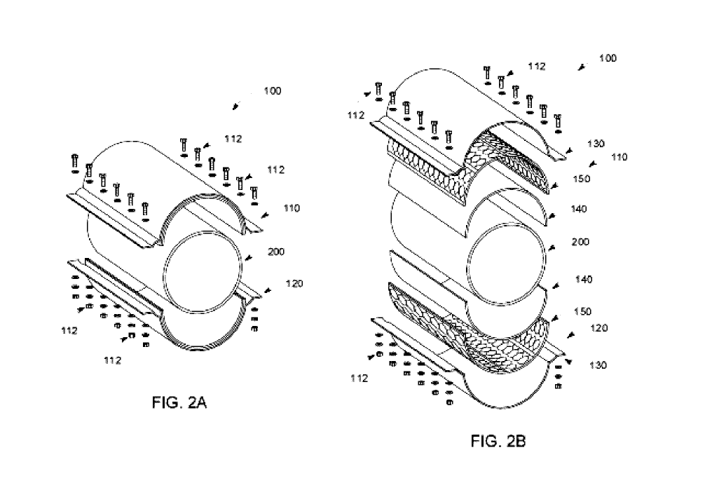

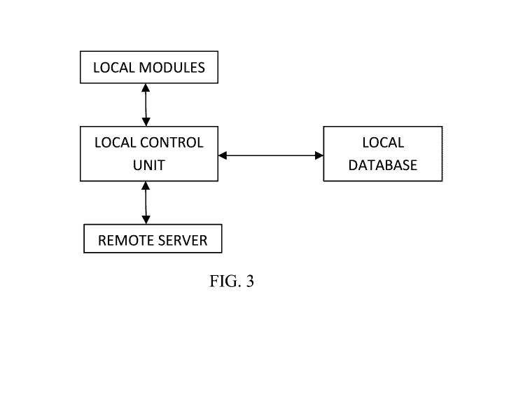

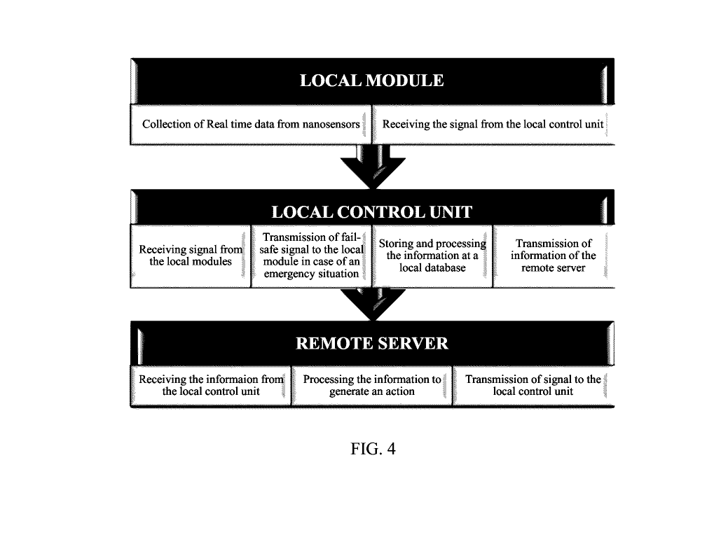

The above noted and other objects, in one aspect, may be achieved by a method or system of the present disclosure. The system comprises a plurality of modules, a local control unit and a database. The modules are designed to be communicably configured to local control unit, and further the local control unit is communicably linked to the database (FIG. 1).

In one embodiment, each module includes at least one flexible composite layer, at least one layer of electronic circuitry and a plurality of nanosensors. A combinational arrangement of all the above when associated with the pipeline are able to generate a plurality of real time data relating to the pipeline, such as pipeline leakage, prediction of stress and strain, fatigue measurement, corrosion and erosion, future leakage or failure, and detection of any attempt to theft or tempering in the pipeline. Further, all the real time data that is generated using modules is collected and transferred to a local control unit.

In one of the embodiment, the local control unit which is designed to communicably configure with the plurality of modules receives such real time data relating to the pipeline system and the data received is stored at the local control unit.

In one of the embodiment, the local control unit stores the plurality of information in a local database. Further, the storage of information in the local database helps to arrange the data into the meaningful information.

In one of the embodiment, the local control unit analyzes the stored meaningful information and segregates the information into critical information and non-critical information. The information is critical or not can be done on the basis of the parameters provided to the database.

In one of the embodiment the local control unit is communicably linked to a remote server. Further, the communication of information to the remote server is decided on the basis of the segregation. In one of the embodiment, the local control unit passes only the critical information to the remote server. The transfer of only critical information to the remote server reduces the net burden of communication system. The reduction in amount of data speeds up the data transfer process.

Further, the critical data transferred to the remote server is received as an input signal by the remote server. The remote server receives the input signal, stores and processes the signal, and generates an instruction data which is sent as an output signal to the local control unit on the basis of the input signal received. The local control unit receives the output signal from the remote server and stores the received instruction data in the local database. The instruction data is segregated in the database and further transmitted to the respective modules in case any final action needs to be taken.

In one of the preferred embodiment, the local control unit self-trains itself on the basis of the instruction data signal received as an input signal by the remote server for future or fail-safe actions. In one of the embodiments the self-training is done by using an Artificial Neural Network (ANN) module. This may provide Artificial Intelligence to the entire pipeline system and the turnaround time for action based on information may reduce.

In one of the preferred embodiment, the local control unit in case of an emergency situation can transmit a failsafe signal. Later, another signal can be received by the remote sever according to which the action can be taken by the local modules. The emergency situations can be pre-defined to the local control unit. Further, these situations can be modulated on the basis of the self-training module that the local control unit may go through.

In one of the preferred embodiment, at least one of the nanosensors is a Global Positioning System (GPS) nanosensor, to enable the communication between the plurality of modules and the local control unit. In one of the preferred embodiment, the communication of the information between modules, local control unit and remote server is done through GPS.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed:

1. A system for automatic data collection, wherein the system comprises:
a. a plurality of modules for data collection, wherein modules are dispersed on a pipeline to generate a plurality of real time data;
b. a local control unit communicably configured to the modules, wherein the local control unit collects and collates the data collected by the modules and organizes the data into meaningful information; and
c. a remote server, wherein remote server send-receives the information with the local control unit.

2. The system as claimed in claim 1, wherein the modules comprises of:
a. at least one flexible composite layer;
b. at least one layer of electronic circuitry embedded on the flexible composite layer,
c. a plurality of nanosensors embedded on the flexible composite layer in combinational arrangement with the electronic circuitry, wherein the combinational arrangement of the nanosensor and the electronic circuitry on the flexible composite layer are capable to monitor and process a plurality of parameters associated with the pipeline to generate at least one of the plurality of real time data relating to the pipeline.

3. The local control unit as claimed in claim 1, wherein the local control unit is linked to a local database.

4. The database as claimed in claim 3, wherein the database is linked to a self-training module of the local control unit.

5. The self-training module as claimed in claim 4 is an Artificial Neural Network (ANNs) module.

6. A method for automatic data collection, wherein the method comprises the steps of:
a. collecting a real time data from modules;
b. transferring the data from the modules to a local control unit, where the data is stored as information;
c. sorting the information on a basis of a plurality of parameters, where the parameters are predefined;
d. transferring any critical information to a remote server, wherein the remote server receives, stores and processes the information, and generates an instruction data which is sent as an output signal;
e. transferring the output signals to the local control unit, where signals are stored in a database;
f. generating, at the local control unit, a signals for local modules, and
g. transmitting the signals to the local modules for a final action.

7. The method as claimed in claim 6, wherein the local control unit can transmit a failsafe signal to the local module in case of an emergency situation.

8. The method as claimed in claim 6, wherein the local control unit has a local database for the storing and sorting of information.

9. The database as claimed in claim 6, wherein the database has an Artificial Neural Network system which may self-train the local control unit.
